(19) United States
(12) Patent Application Publication
(10) Pub. No.: US 2017/0298687 A1
(43) Pub. Date: Oct. 19, 2017

(54) REELING DEVICE FOR WINDOW COVERING

(71) Applicant: NIEN MADE ENTERPRISE CO., LTD., Taichung City (TW)

(72) Inventors: Lin CHEN, Taichung City (TW); Keng-Hao NIEN, Taichung City (TW)

(21) Appl. No.: 15/132,438

(22) Filed: Apr. 19, 2016

(51) Int. Cl. E06B 9/322; E06B 9/323

(52) U.S. Cl. CPC E06B 9/322; E06B 9/323

(57) ABSTRACT

A reeling device for a window covering is disclosed, including a base having a perforation, an end cap, and a rotating member engaged to the base. The rotating member is rotatable around an axis, and has a body portion having a first end and a second end. An end of the lifting cord is engaged to the body portion near the first end, while another end passes through the perforation and winds around the second end. The end cap is engaged to the first end and is rotatable, which includes a tapered sleeve and a tubular body fitting around the body portion to cover a cord segment engaged to the body portion; the tapered sleeve is connected to the tubular body, and an outer diameter thereof decreases in a direction away from the first end. Such structure is helpful to control a lifting cord to smoothly operate a shade material.

### BACKGROUND OF THE INVENTION

### 1. Technical Field

The present invention generally relates to structures of window coverings, and more particularly to a reeling device for a window covering.

### 2. Description of Related Art

Typically, a window covering includes a headrail, a bottom rail, and a shade material, through which at least two lifting cords pass, and the shade material is located between the headrail and the bottom rail. Such a window covering commonly further include two reeling devices and a rotating shaft which are disposed in the headrail or the bottom rail, wherein the reeling devices can be rotated by the rotating shaft to roll up or release the lifting cords, whereby the shade material can be raised or lowered. Optimally, each of the lifting cords should wind around the corresponding reeling device in an axial direction of the reeling device without overlapping itself; in this way, the shade material can be smoothly raised or lowered. However, a lifting cord tends to bounce randomly while being wound around the reeling device due to improper operation, uneven pulling speed, or collision between the shade material and other objects, which may lead to insufficient tension for the lifting cord. Such random bounces may cause the lifting cord to overlap itself, or form loose loops in the case of insufficient tension. These loose loops may wind around components other than the reeling device. Furthermore, the lifting cord may get tangled after having random bounces, and as a result, the shade material would not be able to be raised or lowered smoothly.

In order to solve such problem, an improved reeling device is disclosed in a Chinese patent, of which the publication number is CN101426999A. The patent discloses a movable shaft and a transition member, wherein the movable shaft is provided on a cradle, and has an end portion and a lift cord wrapping portion. The transition member is tilted, and is disposed between the end portion and the lift cord wrapping portion in a way of making the lifting cord move toward the lift cord wrapping portion to prevent the cord from being tangled. Though such design is useful for improving the problem of generating tangled cord, it fails to deal with random bounces of the lifting cord. That's because the outer edges of the lift cord wrapping portion and the transition member are close, and the junction of the lift cord wrapping portion and the transition member is a flat surface. Therefore, with improper operation or collision happening between the shade material and other objects while rolling up the lifting cord, random bounces may still happen on the flat surface. Furthermore, the movable shaft disclosed in the patent would shift laterally while winding the lifting cord around it, and therefore, it requires more reserved space for its operation, which puts more limitations on the selection of types of window coverings. Thus, the reeling device disclosed in the patent CN101426999A still has room for improvement.

### BRIEF SUMMARY OF THE INVENTION

In view of the reasons mentioned above, the primary objective of the present invention is to provide a reeling device for a window covering, which could smoothly raise or lower the window covering.

The present invention provides a reeling device for a window covering, which includes a rail and a shade material, wherein the reeling device is provided in the rail to roll up or release a lifting cord to raise or lower the shade material; the lifting cord is engaged to the reeling device with an end thereof. The reeling device includes a rotating member and an end cap. The rotating member is controllable to rotate around an axis, wherein the rotating member has a body portion, of which two opposite ends are a first end and a second end respectively; the end of the lifting cord which is engaged to the reeling device is near the first end of the body portion; another end of the lifting cord passes through a bore of the rail and winds around the second end. The end cap is connected to the first end of the body portion, wherein the end cap includes a tubular body and a tapered sleeve; the tubular body fits around the body portion to cover a segment of the lifting cord which is connected to the body portion; the tapered sleeve is connected to the tubular body, and an outer diameter thereof gradually decreases in a direction away from the first end.

In an embodiment, the reeling device further includes a base, which is provided in the rail, and has a perforation thereon, wherein the lifting cord passes through the perforation and the bore of the rail; the rotating member is rotatably connected to the base.

In an embodiment, the base has a recess, and the rotating member has a tail portion, which is connected to the second end of the body portion, and is in the recess, so that the rotating member is rotatable in situ while being engaged to the base.

In an embodiment, the tail portion of the rotating member has two opposite lateral surfaces, each of which faces a lateral wall of the base respectively to engage the rotating member to the base.

In an embodiment, the reeling device further includes a shell connected to another side of the base opposite to a side thereof which is provided with the perforation, wherein a front edge of the shell extends to pass a projection range of the perforation.

In an embodiment, the end cap and the rotating member are provided coaxially around the axis, and are rotatable in a same direction.

With the invention above, the chances of having random bounces for the lifting cord is reduced. Furthermore, with the structure of the end cap, when the lifting cord winds around portions other than the body portion of the rotating member, by repeatedly releasing and rolling up the lifting cord, the lifting cord could return to the state of winding around the rotating member in an axial direction of the rotating member without overlapping itself, whereby a shade material could be raised or lowered smoothly.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view, showing a window covering which includes the reeling device of a first preferred embodiment of the present invention;

FIG. 2 is an exploded view; showing the reeling device in FIG. 1;

FIG. 3 is a sectional view, showing the lifting cord is released by the rotating member in FIG. 2;

FIG. 4 is a top view, showing the lifting cord is rolled up by the rotating member in FIG. 2;

FIG. 5 is a top view, showing that the lifting cord has random bounces, which causes some segments of the lifting cord to overlap the end cap;

FIG. 6 is a perspective view, showing the reeling device of a second preferred embodiment of the present invention; and

FIG. 7 is a sectional view along the 7-7 line in FIG. 6, showing the arrangement of the lifting cord and the reeling device.

### DETAILED DESCRIPTION OF THE INVENTION

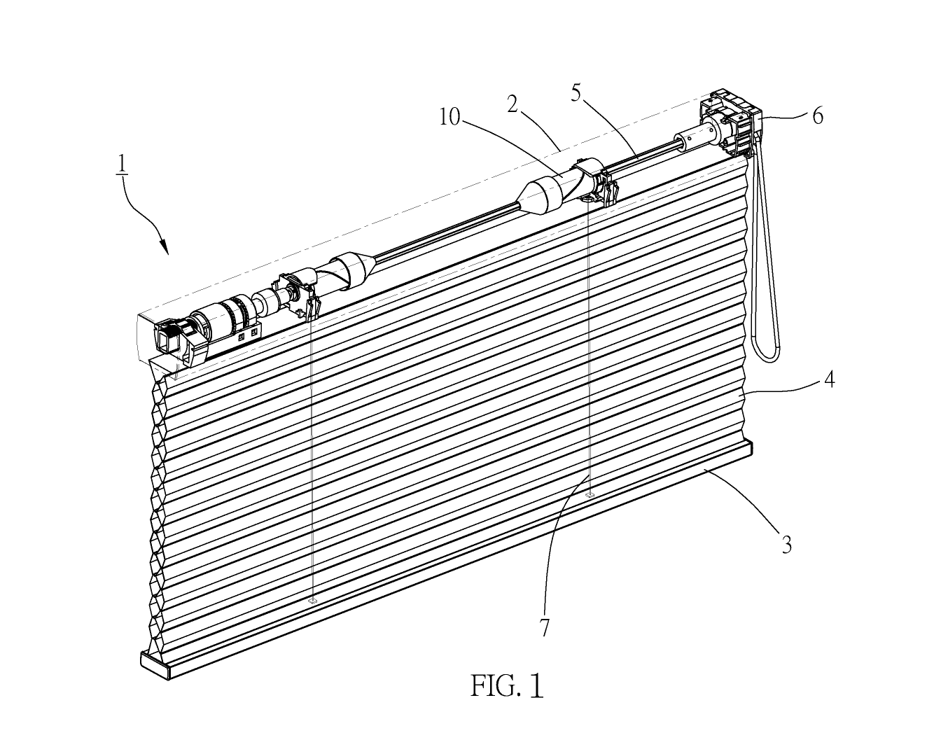

A window covering 1 including a reeling device 10 of the first preferred embodiment of the present invention is shown in FIG. 1. As usually seen in a common window covering, the window covering 1 is installed with two reeling devices 10.

The window covering 1 includes a rail, which is a headrail 2 as an example, a bottom rail 3, a shade material 4, a shaft 5, a control device 6, and two lifting cords 7. The shade material 4 is provided between the headrail 2 and the bottom rail 3. The shade material 4 illustrated in FIG. 1 is a cellular shade; however, it can be a drape or a composition of a plurality of slats in practice. The shaft 5 is a polyhedron provided in the headrail 2, and it can be rotated clockwise and counterclockwise by the control device 6. When the shaft 5 is controlled and rotated, each of the reeling devices 10 is driven to roll up or release the lifting cords 7. In this way, the shade material 4 can be raised or lowered by the lifting cords 7. In practice, the shaft 5, the control device 6, and the reeling device 10 can be alternatively provided in the bottom rail 3 to meet different requirements of operation, installation, or different kinds of window coverings.

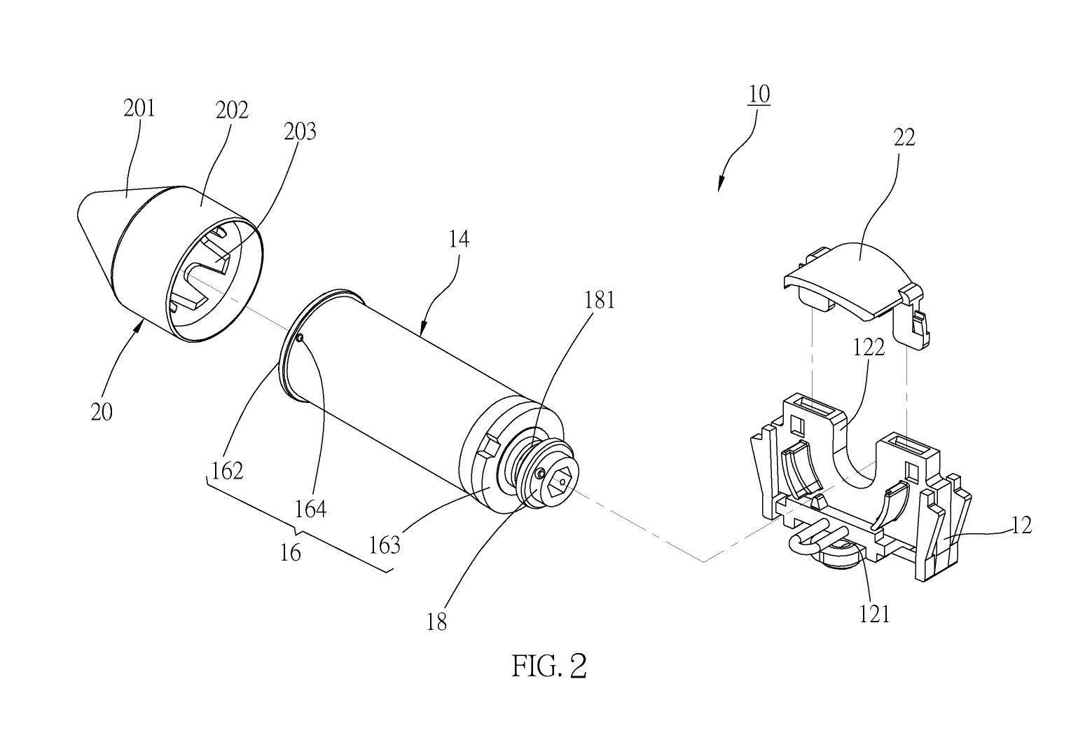

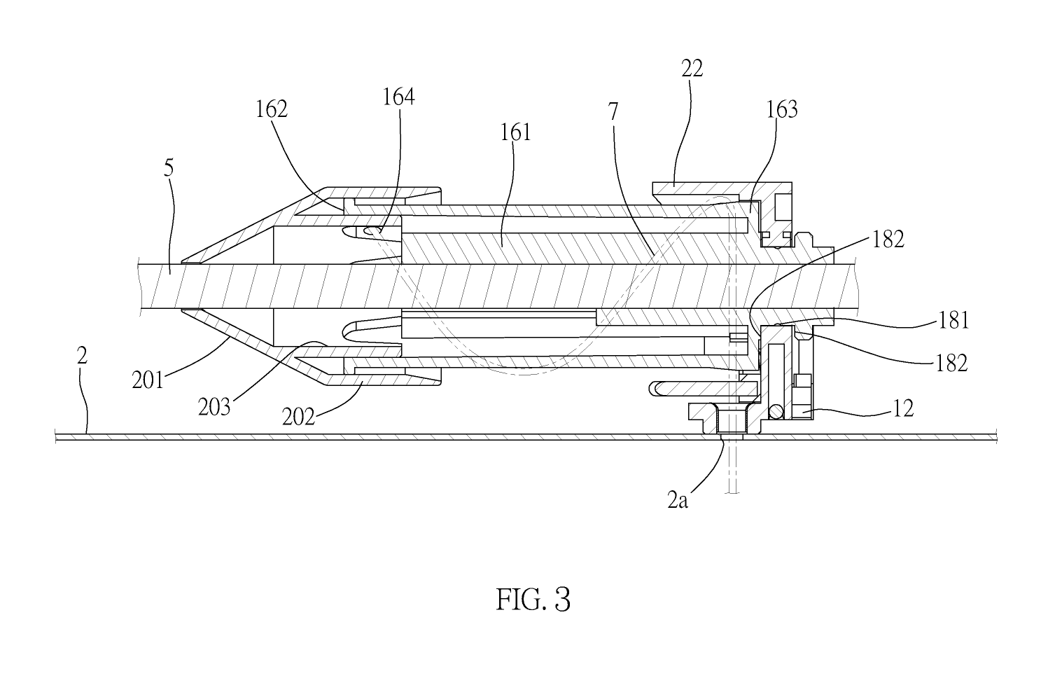

For convenience of reference, we will only take one of the reeling devices 10 to further explain its internal structure. As shown in FIG. 2 and FIG. 3, the reeling device 10 includes a base 12, a rotating member 14, an end cap 20, and a shell 22.

The base 12 is fixed in the headrail 2, and has a perforation 121 and a U-shaped recess 122, wherein the opening of the U-shape faces upward, and the perforation 121 is near a bore 2a on a bottom surface of the headrail 2.

The rotating member 14 is a cylinder, which is provided in the headrail 2, with the shaft 5 passing therethrough. The rotating member 14 has a body portion 16 and a tail portion 18. An inner surface of the body portion 16 is provided with a plurality of blocks 161, which surround an outer surface of the shaft 5 to firmly engaging the rotating member 14 to the shaft 5, so that the rotating member 14 can be rotated along with the shaft 5 around a same axis. Two opposite ends of the body portion 16 are respectively defined as a first end 162 and a second end 163, wherein the body portion 16 is provided with an engaging hole 164 on a wall near the first end 162. The lifting cord 7 is knotted at an end thereof after passing through the engaging hole 164, and is therefore engaged to the body portion 16. The lifting cord 7 winds around the body portion 16 in an axial direction of the rotating member 14 without overlapping itself. Another end of the lifting cord 7 sequentially passes through the perforation 121 of the base 12, the bore 2a of the headrail 2, and the shade material 4, and then is fixedly engaged to the bottom rail 3. The bore 2a and the perforation 121 are both near the second end 163 of the rotating member 14.

An outer diameter of the tail portion 18 is less than an outer diameter of the body portion 16, wherein the tail portion 18 is connected to the second end 163 of the body portion 16 with an end thereof. The tail portion 18 has a groove 181, which has two opposite lateral surfaces 182. The tail portion 18 is fitted in the recess 122 of the base 12 with each of the lateral surfaces 182 respectively faces one lateral wall of the base 12. In this way, the rotating member 14 can be rotated in situ while being engaged to the base 12.

The shaft 5 passes through the end cap 20, wherein the end cap 20 can be rotated together by the shaft 5 around the axis. The end cap 20 includes a tapered sleeve 201 and a tubular body 202, wherein the tapered sleeve 201 is connected to an end edge of the tubular body 202, and an outer diameter thereof gradually decreases in a direction away from the first end 162 of the body portion 16.

The tubular body 202 fits around the first end 162 of the body portion 16, and covers a portion where the lifting cord 7 is connected to the body portion 16. In the first preferred embodiment, the end cap 20 further includes a tube 203. As shown in FIG. 3, the tube 203 and the tubular body 202 are coaxial, and an end edge of the tube 203 is connected to an inner wall of the tapered sleeve 201. When the tubular body 202 fits around the body portion 16, an outer surface of the tube 203 and an inner surface of the tubular body 202 tightly hold the body portion 16 collectively on two sides thereof, so that the end cap 20 and the body portion 16 are tightly engaged with each other.

In addition, a gap is left between the inner surface of the tubular body 202 and an outer surface of the body portion 16 to merely accommodate the lifting cord 7 which non-overlappingly winds around the body portion 16. In this way, a segment of the lifting cord 7 covered by the tubular body 202 would have less chance of bouncing randomly due to the limitation provided by the end cap 20 and the body portion 16. Therefore, the segment of the lifting cord 7 covered by the tubular body 202 would not leave the body portion 16 to overlap another uncovered segment of the lifting cord 7.

The shell 22 is connected to a top edge of the base 12, i.e., another side of the base 12 opposite to the side provided with the perforation 121. A front edge of the shell 22 extends in the axial direction of the rotating member 14, and passes a projection range of the perforation 121 to cover an upper portion of the tail portion 18 and the body portion 16. A gap is left between the bottom surface of the shell 22 and an outer surface of the rotating member 14, wherein, again, the gap is merely capable of accommodating the lifting cord 7 non-overlappingly winds around the body portion 16, In other words, a segment of the lifting cord 7 covered by the shell 22 would have less chance of bouncing randomly due to the limitation provided by the gap between the shell 22 and the body portion 16.

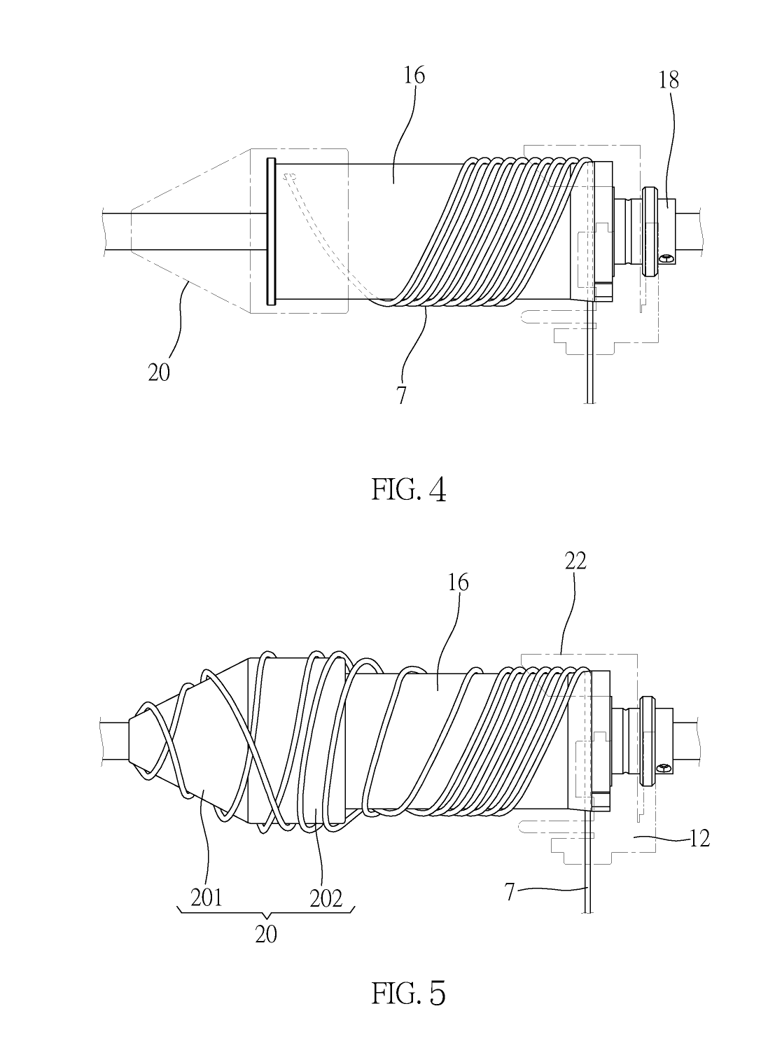

With the aforementioned design, when the shaft 5 is rotated by the control device 6, the rotating member 14 and the end cap 20 are driven to rotate synchronously. As a result, the lifting cord 7 is released as shown in FIG. 3. After that, the lifting cord 7 lowers the shade material 4. Alternatively, the lifting cord 7 can also be rolled up as shown in FIG. 4, and the shade material 4 is raised in this case.

During the process of raising or lowering the shade material 4, if a segment of the lifting cord 7 which is not covered by the shell 22 or the end cap 20 (i.e., the segment at a middle part of the body portion 16) bounces randomly due to improper or careless operation, and the lifting cord 7 is loosed to wind around portions other than the body portion 16, as shown in FIG. 5. The lifting cord 7 could be guided to move toward the body portion 16 by controlling the control device 6 to indirectly rotate the rotating member 14 and the end cap 20, since the outer diameter of the tapered sleeve 201 gradually decreases in the direction away from the first end 162 of the body portion 16.

A preferred way for troubleshooting is as follow: releasing the lifting cord 7 by controlling the control device 6 to rotate the reeling device 10 till the shade material 4 is fully expanded. During such process, the rotating end cap 20 would make the lifting cord 7 move toward the body portion 16 through a tapered surface of the tapered sleeve 201, and the segment of the lifting cord 7 around the body portion 16 would be gradually released along with the lowering of the shade material 4 (as shown in FIG. 3). In this way, by controlling the control device 6 to rotate the reeling device 10 to roll up the lifting cord 7 again, the lifting cord 7 could be wound around the body portion 16 in an axial direction of the body portion 16 without overlapping itself, and eventually return to the state illustrated in FIG. 4. The shade material 10 could be smoothly raised or lowered afterwards.

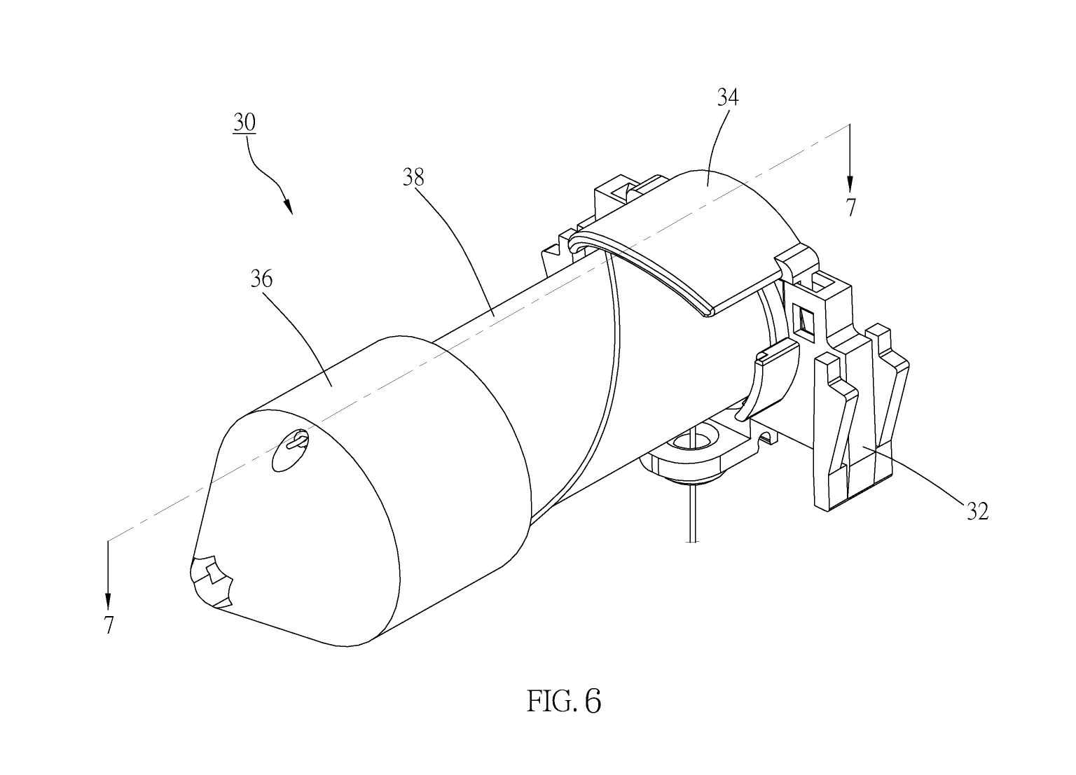

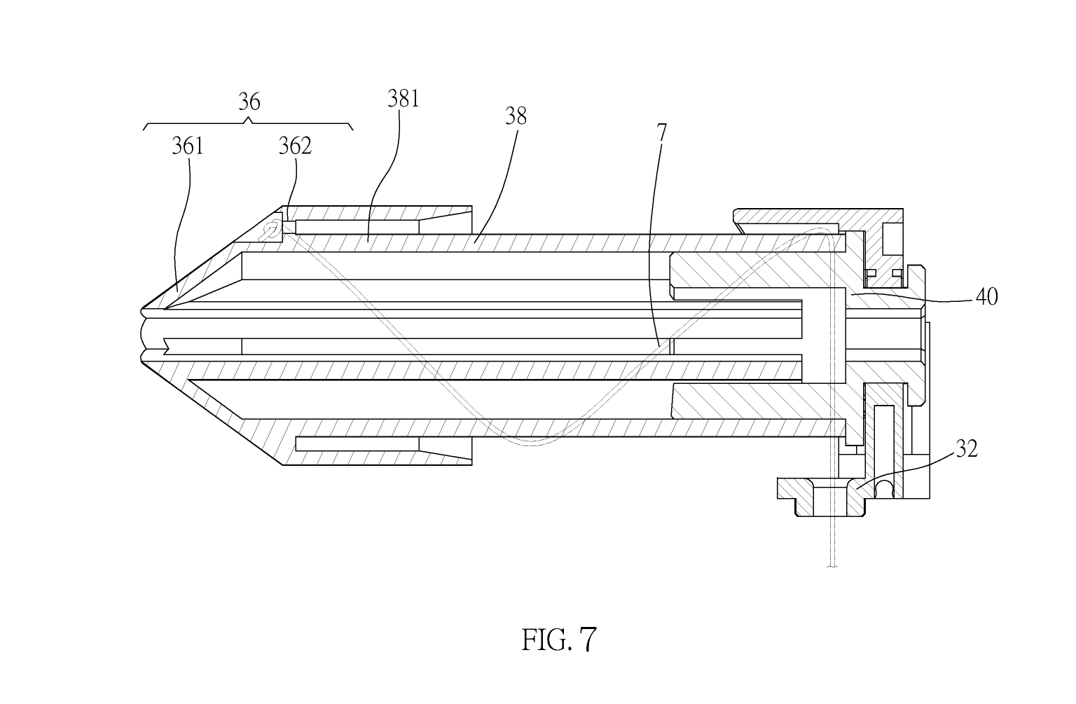

A reeling device 30 of a second preferred embodiment of the present invention is shown in FIG. 6, which could be used in the aforementioned window covering 1. Similarly, the reeling device 30 also includes a base 32, a shell 34, an end cap 36, and a rotating member, as included in the reeling device 10 of the first preferred embodiment. As shown in FIG. 7, the differences between the second preferred embodiment and the first preferred embodiment include that, the end cap 36 and a body portion 38 of the rotating member are integrally formed, while a tail portion 40 of the rotating member is another component separated from the body portion 38. In addition, a tapered sleeve 361 of the end cap 36 has an engaging hole 362 thereon; the lifting cord 7 is engaged to the reeling device 30 with an knotted end thereof after passing through the engaging hole 362, whereby the lifting cord 7 is fixed on the end cap 36, and is near a first end 381 of the body portion 38, so that the lifting cord 7 could fit into a gap formed between the end cap 36 and the body portion 38. On the other hand, another end of the lifting cord 7 is fixed to the bottom rail 3 after passing through the base 32 and the shade material 4. Whereby, the shade material 4 can be raised or lowered.

With the aforementioned design of the reeling device 30, if the lifting cord 7 has random bounces and gets tangled at portions other than the body portion 38, the lifting cord 7 can be moved toward the base 32 and wound around the body portion 38 again without overlapping itself by repeatedly releasing and rolling up the lifting cord 7. The effect of smoothly raising or lowering the shade material 4 could be achieved in this way.

In summary, each of the reeling devices 10, 30 of the preferred embodiments of the present invention uses the specific gaps formed between the end cap (and the shell) and the body portion to restrict the segments of the lifting cord accommodated in the gaps, whereby the lifting cord can only wind around the body portion in a non-overlapping way, which reduces the chances of having random bounces. In addition, even if random bounces do happen, by releasing and rolling up the lifting cord 7, the lifting cord 7 could be guided to move toward the rotating member due to the tapered surface of the tapered sleeve. Whereby, the lifting cord 7 could return to the state of being wound around the body portion without overlapping itself to achieve the effect of smoothly raising or lowering the shade material 4.

It must be pointed out that the embodiments described above are only some preferred embodiments of the present invention. All equivalent structures which employ the concepts disclosed in this specification and the appended claims should fall within the scope of the present invention.

What is claimed is:

1. A reeling device for a window covering, which includes a rail and a shade material, wherein the reeling device is provided in the rail to roll up or release a lifting cord to raise of lower the shade material; the lifting cord is engaged to the reeling device with an end thereof; comprising:
a rotating member, which is controllable to rotate around an axis, wherein the rotating member has a body portion, of which two opposite ends are a first end and a second end respectively; the end of the lifting cord which is engaged to the reeling device is near the first end of the body portion; another end of the lifting cord passes through a bore of the rail and winds around the second end; and
an end cap, which is connected to the first end of the body portion, wherein the end cap includes a tubular body and a tapered sleeve; the tubular body fits around the body portion to cover a segment of the lifting cord which is connected to the body portion; the tapered sleeve is connected to the tubular body, and an outer diameter thereof gradually decreases in a direction away from the first end.

2. The reeling device of claim 1, comprising a base, which is provided in the rail, and has a perforation thereon, wherein the lifting cord passes through the perforation and the bore; the rotating member is rotatably connected to the base.

3. The reeling device of claim 2, wherein the base has a recess; the rotating member has a tail portion, which is connected to the second end of the body portion, and is in the recess, so that the rotating member is rotatable in situ while being engaged to the base.

4. The reeling device of claim 3, wherein the tail portion of the rotating member has two opposite lateral surfaces, each of which faces a lateral wall of the base respectively to engage the rotating member to the base.

5. The reeling device of claim 3, comprising a shell connected to another side of the base opposite to a side thereof which is provided with the perforation, wherein a front edge of the shell extends to pass a projection range of the perforation.

6. The reeling device of claim 1, wherein the end cap and the rotating member are provided coaxially around the axis, and are rotatable in a same direction.
